(19) United States
(12) Patent Application Publication
(10) Pub. No.: US 2007/0180225 A1
(43) Pub. Date: Aug. 2, 2007

(54) Method and system for performing authentication and traffic control in a certificate-capable session

(76) Inventor: Jeffrey A. Schmidt, Hilliard, OH (US)

Correspondence Address: CALFEE HALTER & GRISWOLD, LLP, 800 SUPERIOR AVENUE, SUITE 1400, CLEVELAND, OH, 44114, US

(21) Appl. No.: 11/361,554

(22) Filed: Feb. 24, 2006

Related U.S. Application Data
(60) Provisional application No. 60/655,957, filed on Feb. 24, 2005.
(60) Provisional application No. 60/656,443, filed on Feb. 24, 2005.
(60) Provisional application No. 60/692,200, filed on Jun. 20, 2005.

(51) Int. Cl. H04L 9/00

(52) U.S. Cl. 713/152

(57) ABSTRACT

An apparatus performs authentication of a remote host and traffic control by analyzing the contents of a digital certificate of the remote host. A switch may be used to control operation of the apparatus.

### RELATED APPLICATIONS

The present application is being filed as a U.S. non-provisional patent application claiming priority from U.S. provisional patent application No. 60/655,957 filed on Feb. 24, 2005; U.S. provisional patent application No. 60/656,443 filed on Feb. 24, 2005; U.S. provisional patent application No. 60/692,200 filed on Jun. 20, 2005; and U.S. provisional patent application No. ______, entitled Device, Method And Service Provider For Cryptographically And Transparently Authenticating A Network Device, filed on Jan. 11, 2006, the disclosures of which are being incorporated herein by reference in their entirety.

### FIELD

The invention relates generally to information security and, more particularly, to authentication and traffic control.

### BACKGROUND

Computers often share data with one another over a network. Additionally, networks may be interconnected to form larger networks. For example, the Internet is a worldwide system of interconnected computer networks. The exchange of data between computers over a network raises various security concerns with respect to the information being transmitted over the network. This is particularly true in the case of sensitive information such as financial information, health care information, etc.

In addition to the risk of unauthorized interception of transmitted data, the vulnerability of information transmitted over networks contributes to problems such as identity theft, phishing schemes, etc. Identity theft refers to the deliberate assumption of another person's identity usually for financial gain. For example, a perpetrator might use the person's information (e.g., name, address, social security number, etc.) to obtain a line of credit at a store. The perpetrator then uses the line of credit to steal merchandise.

Phishing is a form of social engineering wherein one attempts to fraudulently acquire the sensitive information (e.g., passwords) of another by masquerading as a trustworthy person or entity in an apparently official electronic communication (e.g., e-mail). For example, a user receives an e-mail with a link to an Internet site claiming to be her bank. She connects to the Internet site and sees content that looks identical to that of her bank. Accordingly, she enters her information, as requested by the site. However, the site is fake and steals her data. Another concern is the practice of pharming, which is a technical variation of phishing.

Authentication is useful for reducing the risks of transmitting data over a network. Authentication refers to a process by which a computer or user attempts to confirm the identity of another computer or user from which information has been received. Authentication is often achieved through the use of digital certificates and certificate-capable sessions. A digital certificate is an electronic file that associates a public key with the real identity of a person, server or other entity, known as the subject. The digital certificate is issued by a trusted third party known as a certificate authority (CA) or issuer after verifying the identity of the subject. The digital certificate can be used to authenticate the subject (e.g., a user, web site, etc.) and optionally to protect data exchanged over a network from theft and tampering. The digital certificate may correspond to an industry standard digital certificate format such as the X.509, the Secure Sockets Layer (SSL), the Secure Shell (SSH) and the Pretty Good Privacy (PGP) formats.

A digital certificate 100, which is structured according to the conventional X.509 standard (version 1), is shown in FIG. 1. The digital certificate 100 corresponds to the domain name www.freesoft.org. The digital certificate 100 has several fields of information including a version number 102 of the X.509 standard according to which the digital certificate 100 was created; a serial number 104 of the digital certificate 100; an algorithm 106 used to sign the digital certificate 100 (i.e., using a public-key digital signature); information on the issuer 108 (e.g., Thawte Consulting); information on a validity period 110 for the digital certificate 100 (i.e., defined as a period 112 before which the digital certificate 100 is deemed invalid and a period 114 after which the digital certificate 100 is deemed invalid); information on the subject 116; information on the subject's public key 118, including a public key algorithm 120 and the public key 122 itself (comprising a modulus 124 and public exponent 126); a digital signature 128 and information on an algorithm 130 used for creating the digital signature 128. Here, the digital signature 128 is computed by taking a Message-Digest algorithm 5 (MD5) hash of the first part of the digital certificate 100 and encrypting it with the issuer's private key. The digital certificate 100 was issued and signed by Thawte Consulting (presently Verisign), as indicated in its issuer field 108. The subject field 116 contains information on the subject including its common name (i.e., www.freesoft.org). This common name is what must match the remote host (e.g., the server 204) being authenticated.

The SSL protocol, the Transport Layer Security (TLS) protocol, the SSH protocol and the Secure Multipurpose Internet Mail Extensions (S/MIME) protocol are examples of protocols that support certificate-capable sessions. In the SSL protocol, a certificate capable session provides secure communication between a client and a server by allowing mutual authentication, the use of digital signatures on messages for integrity and encryption for privacy. According to one scenario, described with reference to FIGS. 2 and 3, a conventional (certificate-capable) SSL session 200 is established via a “handshake” sequence 300 between the client 202 and the server 204 over the Internet 206. The client 202 and the server 204 are connected to the Internet 206 via network connections 208 and 210, respectively. During the handshake, the client 202 (e.g., a user's Web browser) accesses the server 204 (e.g., a Web server) and requests a secure connection (step 302). The server 204 responds by sending its digital certificate 100 to the client 202 (step 304). As noted above, the digital certificate 100 of the server 204 may include information such as the server's name, the server's public key, the identity and digital signature of the issuing CA and the period of time during which the digital certificate 100 is valid. The client 202 uses this information to verify that the digital certificate 100 is valid, is being used by a Web site for which it has been issued and has been issued by a CA that the client trusts. In this manner, the client 202 uses the digital certificate 100 to authenticate the identity of the server 204 (step 306).

Thereafter, in an SSL session, if the server 204 is authenticated (“Yes” in step 308), the client 202 generates a session key and then encrypts the session key with the server's public key (step 310). The client 202 sends the encrypted session key over the Internet 206 to the server 204 so that both the client 202 and the server 204 have a copy of the session key (step 312). The server 204 decrypts the session key using its private key (step 314). Thereafter, data that is transmitted over the Internet 206 between the client 202 and the server 204 can be encrypted and/or decrypted using the session key, which significantly reduces the likelihood of the data being misappropriated and/or misused. Accordingly, the “handshake” process is completed and a secure connection between the client 202 and the server 204 is established (step 316). An icon (e.g., a closed lock) may appear in a Web browser running on the client 202 to indicate that the secure connection has been established. If the server 204 cannot be authenticated, a secure connection is not established between the client 202 and the server 204 and the client 202 should refrain from communication with the server 204 (step 318).

Like authentication, traffic control is useful for reducing the risks of transmitting data over a network. Traffic control refers to regulating communications over a network based on a security policy. Traffic control is often implemented through the use of firewalls. A firewall is hardware and/or software which operates in the network environment to filter the information traveling over the network to another network (i.e., a network firewall) or computer system (i.e., a personal firewall). If an incoming packet of information is flagged by the filters of the firewall, it is not allowed through.

Information sent over a network is often broken up into multiple packets which are individually routed to their intended destination. Firewalls can filter the network traffic based on attributes of these data packets, such as Internet protocol (IP) addresses, ports, domain names, and protocols (e.g., IP, transmission control protocol (TCP), hypertext transfer protocol (HTTP), file transfer protocol (FTP), etc.). With a properly configured firewall in place, information that is dangerous (e.g., a virus), undesired (e.g., spam), etc. may be prevented from passing the firewall and entering the network or computer system.

A conventional system 400 employing a firewall 402 is shown in FIG. 4. The firewall 402 may be, for example, a router located between the client 202 and the Internet 206. A network or data connection 408 connects the firewall 402 to the client 202. The client 202 can define a set of rules that the firewall 402 will use to filter information intended for the client 202 (e.g., information sent from the server 204 to the client 202 over the Internet 206). For example, the rules may define that HTTP traffic is allowed to reach the client 202 but FTP traffic is not allowed to reach the client 202. Accordingly, if a packet of data 404 includes a header portion indicating that the protocol of the data is HTTP, then the firewall 402 allows the packet of data 404 to pass and continue on to client 202 over the network/data connection 408. Conversely, if a packet of data 406 includes a header portion indicating that the protocol of the data is FTP, then the firewall 402 blocks the packet of data 406 from continuing on to the client 202. By carefully defining the rules used by the firewall 402, only traffic that satisfies the defined rules is allowed to the reach the client 202.

Conventional approaches to performing authentication and traffic control to improve information security have shortcomings. For example, it is very difficult to quickly and accurately authenticate a remote host. Furthermore, malicious (e.g., spyware) and/or unwanted (e.g., adware) software may be present on the client, particularly if it is connected to the Internet, such that any client software-based approach to performing authentication of the remote host is suspect. Additionally, current approaches to notifying a user of the current status in a certificate-capable session are lacking. Further still, conventional firewalls do not consider information in a digital certificate (in a certificate-capable session) and instead are limited to analyzing low-level network information such as TCP/IP addresses and ports for performing traffic control.

### SUMMARY

In view of the above, the general inventive concept encompasses performing device authentication and/or traffic control in a certificate-capable session while overcoming the aforementioned shortcomings.

It is an object to quickly and easily authenticate a remote server independent of a local client based on analysis of a digital certificate or similar cryptographic mechanism.

It is another object to perform authentication of a remote server with a high degree of certainty.

It is yet another object to alert a user of an authentication result in a convenient and consistent manner.

It is still another object to perform traffic control by analyzing properties of a digital certificate.

It is yet another object to cryptographically perform unique identification and authentication of a device.

It is another object to provide a hardware or software switch for regulating traffic control in a certificate-capable session.

Numerous advantages and features will become readily apparent from the following detailed description of exemplary embodiments, from the claims and from the accompanying drawings.

### BRIEF DESCRIPTION OF THE DRAWINGS

The invention as well as embodiments and advantages thereof are described below in greater detail, by way of example, with reference to the drawings wherein like reference numbers denote like elements and in which:

FIG. 1 shows a conventional digital certificate, according to the X.509 standard;

FIG. 2 shows a conventional network configuration wherein a certificate-capable session can be established between a client and a server;

FIG. 3 is a flowchart showing a conventional method of establishing an SSL session;

FIG. 4 shows a network configuration with a conventional firewall employed therein;

FIG. 5 shows a system for authenticating a remote host in a certificate-capable session, according to an exemplary embodiment;

FIGS. 6A-6C are a flowchart showing a method of authenticating a remote host in a certificate-capable session, according to an exemplary embodiment;

FIG. 7 shows a system for performing traffic control in a certificate-capable session, according to an exemplary embodiment;

FIG. 8 is a flowchart showing a method of performing traffic control in a certificate-capable session, according to an exemplary embodiment;

FIG. 9 shows a system for performing traffic control in a certificate-capable session, according to an exemplary embodiment;

FIG. 10 shows a system for authenticating a remote host and performing traffic control in a certificate-capable session, according to an exemplary embodiment; and

FIG. 11 shows a system for authenticating a remote host and performing traffic control in a certificate-capable session, according to an exemplary embodiment.

### DETAILED DESCRIPTION

While the general inventive concept is susceptible of embodiment in many different forms, there are shown in the drawings and will be described herein in detail specific embodiments thereof with the understanding that the present disclosure is to be considered as an exemplification of the principles of the general inventive concept. Accordingly, the general inventive concept is not intended to be limited to the specific embodiments illustrated herein.

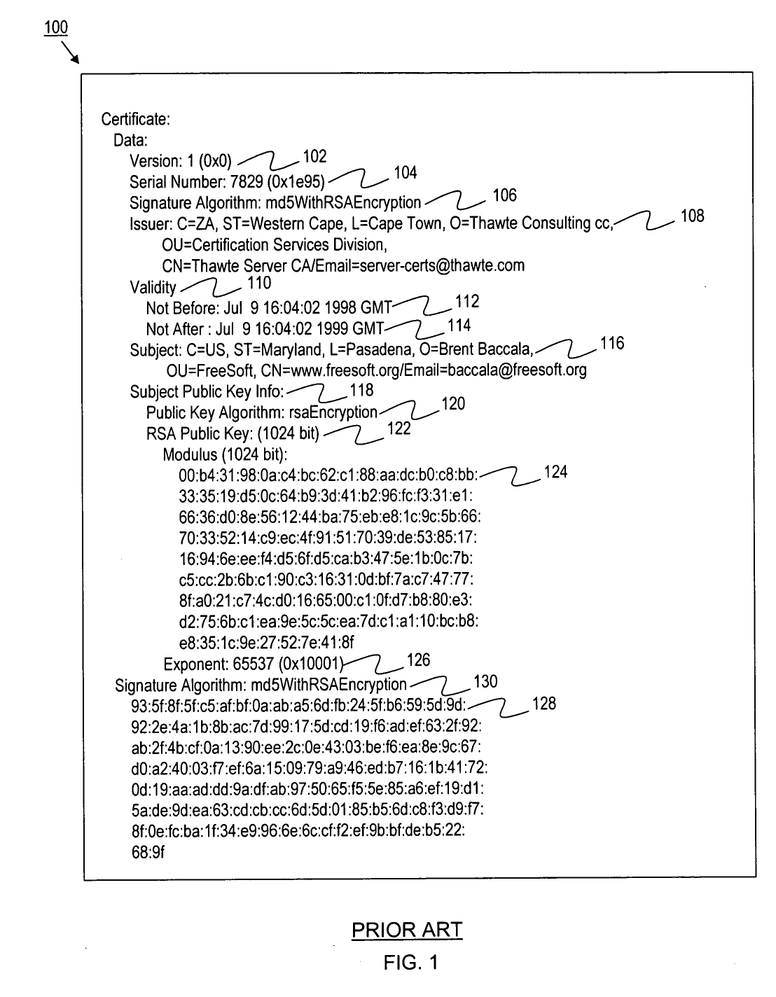

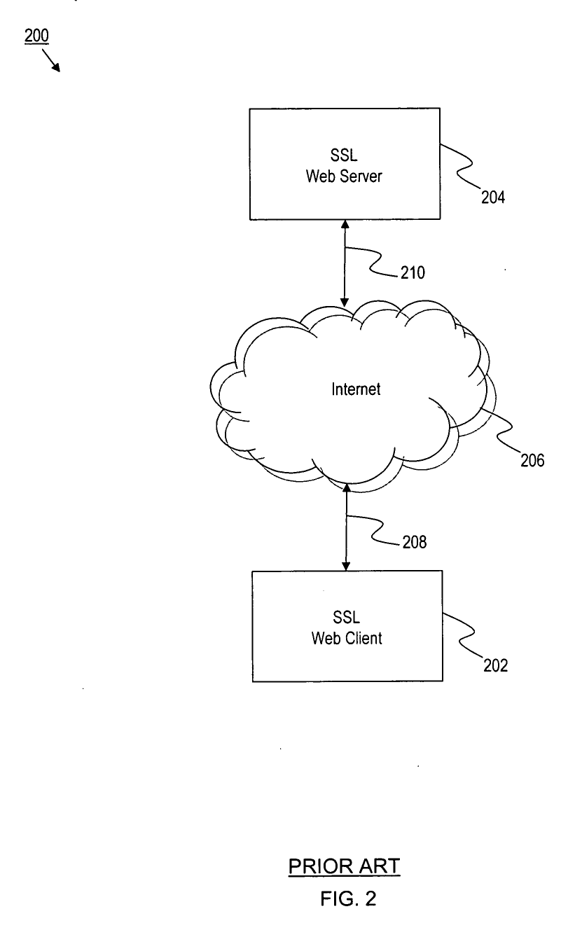

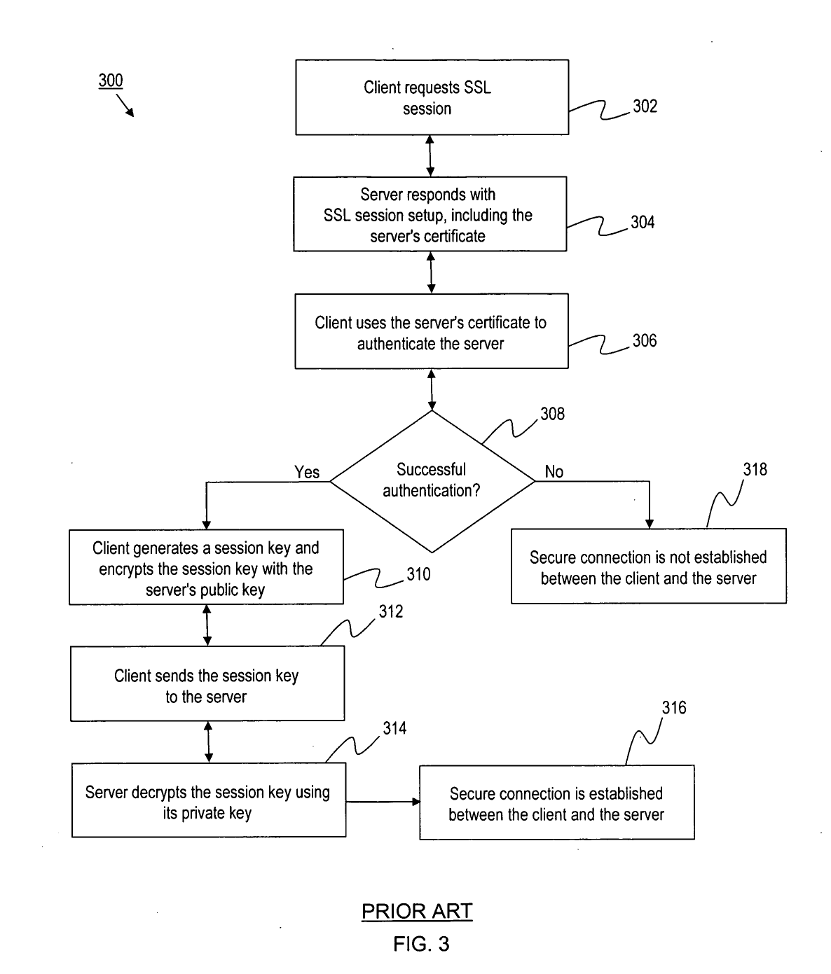

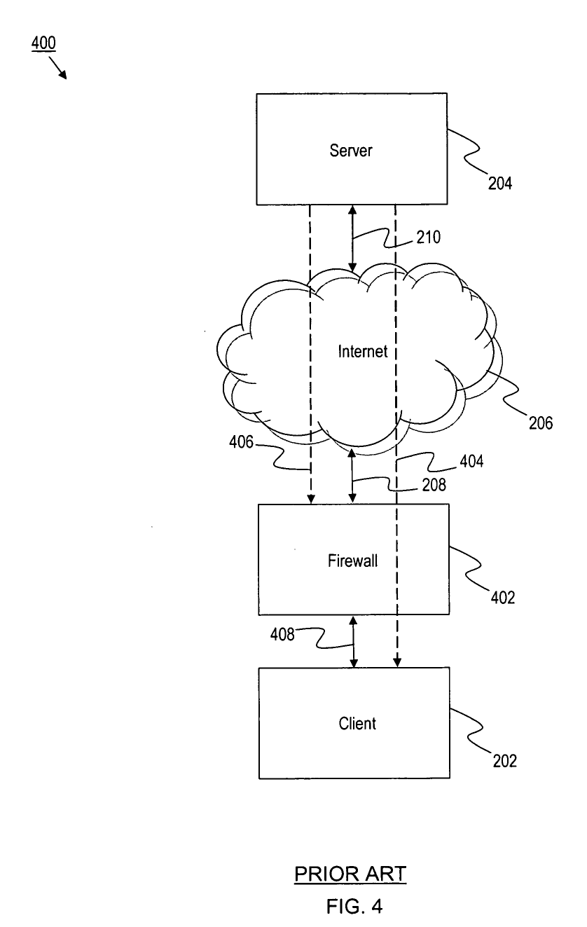

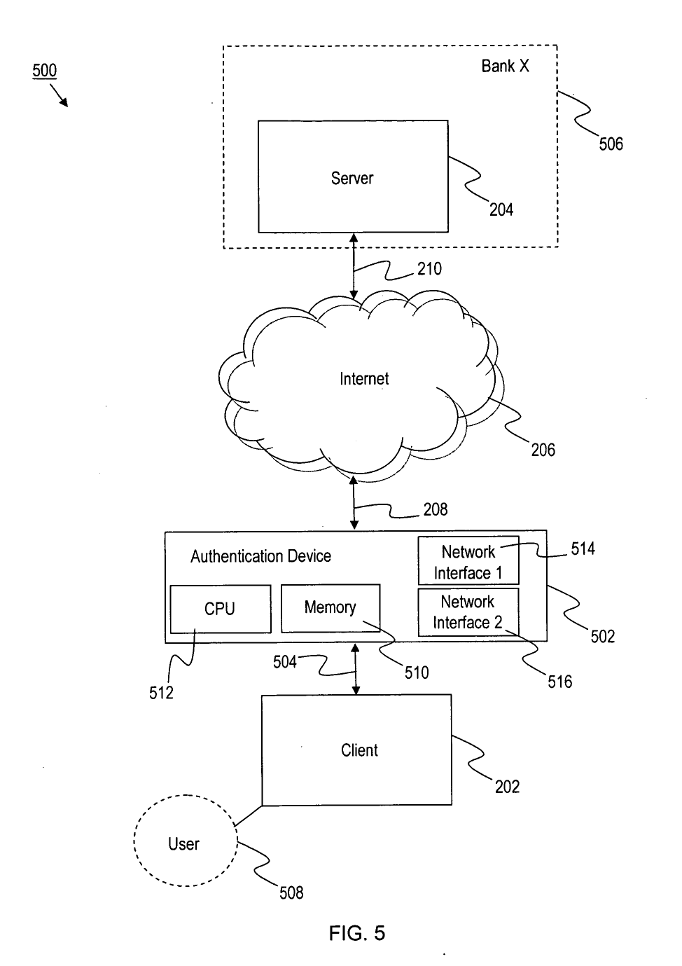

A system 500 for quickly and easily authenticating a remote server 204 in a certificate-capable session, according to an exemplary embodiment, is shown in FIG. 5. In the system 500, a device 502 is provided for authenticating the remote server 204 (e.g., a web server of Bank X 506) independent of a local client 202 (e.g., a web browser of a user 508), based on analysis of a digital certificate 100 of the server 204. As shown in FIG. 1, the digital certificate 100 may, for example, correspond to the X.509 standard. The device 502 authenticates the remote server 204 with a high degree of certainty and alerts the user 508 of the authentication result in a convenient and consistent manner, which is referred to as “server authentication.”

In another scenario, a user or device, such as Bank X, may request identification and authentication of a physical device by means of a digital certificate or similar cryptographic protocol. Identification and authentication of the physical device is useful in determining the authenticity of a user by means of establishing that the user is in physical possession of the device and/or that the physical device resides on the same local network as the user, which is referred to as “site authentication” or “machine/host authentication.”

In one exemplary embodiment, the device 502 is a stand-alone network appliance that monitors a network connection 208. The appliance, in whole or in part, may be implemented as hardware, software or a combination of hardware and software. For example, the device 502 may include memory 510 (e.g., random access memory (RAM) for temporary storage and/or flash memory for persistent storage), a central processing unit (CPU) 512 and one or more network interface units 514, 516, which are operable to monitor network traffic, analyze network traffic and perform authentication based on the monitored network traffic.

In FIG. 5, the device 502 is located in-line in a wired network 504 (e.g., an Ethernet network). The device 502, however, does not necessarily need to be located in-line and will function on any appropriate wired or wireless network. Furthermore, the device 502 could be embedded in a network interface card (NIC), provided as a freestanding network device or integrated into existing network devices/appliances such as routers, firewalls, etc. In FIG. 5, the device 502 is shown as physically separate from the client 202. The device 502, however, does not need to be physically separate from the client 202. For example, the device 502 may be physically and/or logically integrated into the client 202 and/or the infrastructure of the network 504. If so integrated, inspection, validation and decision-making functionality will need to be provided at the client 202 and/or infrastructure of the network 504, which is currently not provided therein. Preferably, but not necessarily, the device 502 is only integrated into the client 202 and/or infrastructure of the network 504 if contemplated advances in trusted hardware and software technologies, such as those from the Trusted Computing Group (TCG), are provided.

Preferably, but not necessarily, the device 502 is logically separate from any communications devices and drivers to enhance security. Preferably, but not necessarily, the device 502 is logically separate from the network medium and the viewing and interaction medium (e.g., the Internet browser) to enhance security. Physical separation of the device 502 is optional and dependent on the security requirements and capabilities of the other system components. For example, the device 502 may be implemented in software on the client 202 if the standards and equipment contemplated in the TCG are in use.

The device 502 observes network traffic flowing between a network (e.g., the Internet 206) and the client 202 by monitoring the network connection 208. If a certificate-capable session (e.g., an SSL session) is detected by the device 502, the device 502 intercepts and analyzes the digital certificate 100 of the server 204 to authenticate the server 204.

Preferably, but not necessarily, the device 502 reviews the digital certificate 100 and notifies the user 508 in real time that a secure certificate-capable session, such as an SSL session, has been initiated. The notification may be presented to the user 508 in any form, such as audibly or visually.

Furthermore, the device 502 may present additional information to the user 508. For example, the device 502 may play a welcome message from Bank X 506 when the digital certificate 100 of the server 204 of Bank X 506 is detected. In this manner, the device 502 offers service providers (e.g., Bank X 506) an additional mechanism for communicating with those individuals (e.g., the user 508) that are using their secure on-line services. The additional information may be presented to the user 508 in any form, such as audibly or visually.

Preferably, but not necessarily, the device 502 notifies the user 508 in real time if the digital certificate 100 of the server 204 is determined to be from a trusted issuer (e.g., Verisign) or is a “whitelisted” certificate. A “whitelist” is an access control mechanism which may be used to enforce a policy of allowing access to known trustworthy entities. The whitelist is a data structure that may be maintained, for example, in the device 502. The notification may be presented to the user 508 in any form, such as audibly or visually.

Preferably, but not necessarily, the device 502 notifies the user 508 in real time if the digital certificate 100 of the server 204 is unrecognized or determined to be invalid. Additionally, the device 502 may notify the user 508 in real time if the digital certificate 100 of the server 204 is determined to be a “blacklisted” certificate, a certificate issued by a “blacklisted” issuer or a certificate meeting some other negative criteria (e.g., an expired certificate, a self-signed certificate, etc.). A “blacklist” is an access control mechanism which may be used to enforce a policy of denying access to known untrustworthy entities. The blacklist is a data structure that may be maintained, for example, in the device 502. The notification may be presented to the user 508 in any form, such as audibly or visually.

The device 502 is able to track all certificate-capable sessions between the client 202 and the server 204. Accordingly, the device 502 may notify the user 508 in real time if multiple simultaneous certificate-based sessions are in progress. The notification may be presented to the user 508 in any form, such as audibly or visually.

Preferably, but not necessarily, the device 502 notifies the user 508 in real time if any potentially malicious attempt to “hide” undesirable data traffic within desirable data traffic is detected. The notification may be presented to the user 508 in any form, such as audibly or visually.

Preferably, but not necessarily, the device 502 notifies the user 508 in real time if the network traffic fails to comply with a predetermined policy. For example, the device 502 would permit traffic to server 204 of Bank X 506 because the digital certificate 100 of Bank X's server 204 appears on a whitelist. As another example, the device 502 would block access to a phishing site designed to impersonate the site of Bank X 506 because, even though the phishing site has a valid digital certificate 100, the digital certificate 100 belonging to the phishing site does not appear on the whitelist or does not satisfy all the criteria required for allowing passage of the network traffic. The device 502 may evaluate the network traffic with respect to the predetermined policy in conjunction with a certificate-capable session. The notification may be presented to the user 508 in any form, such as audibly or visually.

The device 502 participates in the authentication and/or authorization process (of the server 204) at the application layer. For example, the device 502 may request and/or provide user data, shared secrets, public and/or private digital certificates, cryptographic challenge/response data or other information for the authentication and/or authorization process. The role of the device 502 in the process may be transparent or may occur with interaction by the user 508, a machine (e.g., the client 202) or a third party. Additionally, the device 502 may accept or reject a certificate-capable session at the application layer by redirecting traffic, or at the network layer by dropping and/or resetting certain TCP/IP packets causing the session to close pursuant to the TCP/IP protocols.

The device 502 may be operable to create transaction logs relating to the processing of the device 502. For example, the device 502 may create a log that stores each instance when a certificate-capable session is initiated, denied, attempted, completed, has failed, etc. Additionally, the device 502 may log an event giving rise to any of the aforementioned notifications. Preferably, but not necessarily, the transaction logs are stored electronically. For example, the transaction logs may be stored locally on the device 502 or on the client 202 (e.g., for the user 508 to review) or at a remote location (e.g., for third party analysis).

Any of the aforementioned notifications and the related data may be provided to the user 508 by software installed on the client 202. Additionally, real time feedback may be provided to the user 508 by the software. The software may be a Web page, a modification to a Web page flowing through the device 502, an application installed on the client 202, etc.

With the device 502, the user 508 may remain updated on the status of a certificate-capable session, including whether or not the remote server 204 is successfully authenticated. In this manner, the user 508 can refrain from sharing sensitive information with the server 204 over the Internet 206 if the server 204 cannot be authenticated (e.g., if the user does not hear an audible indication that the server 204 has been authenticated).

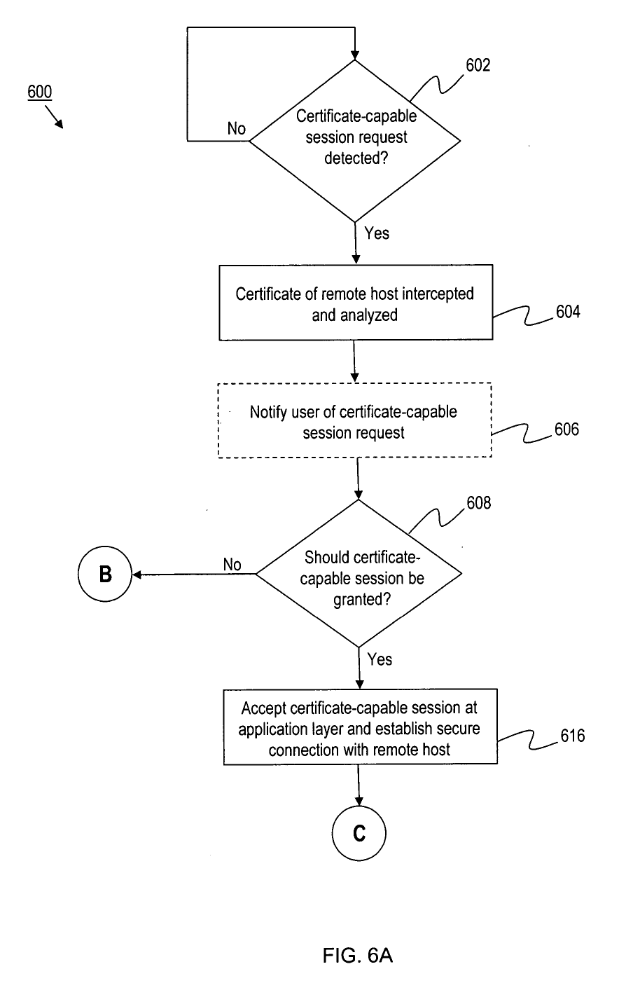

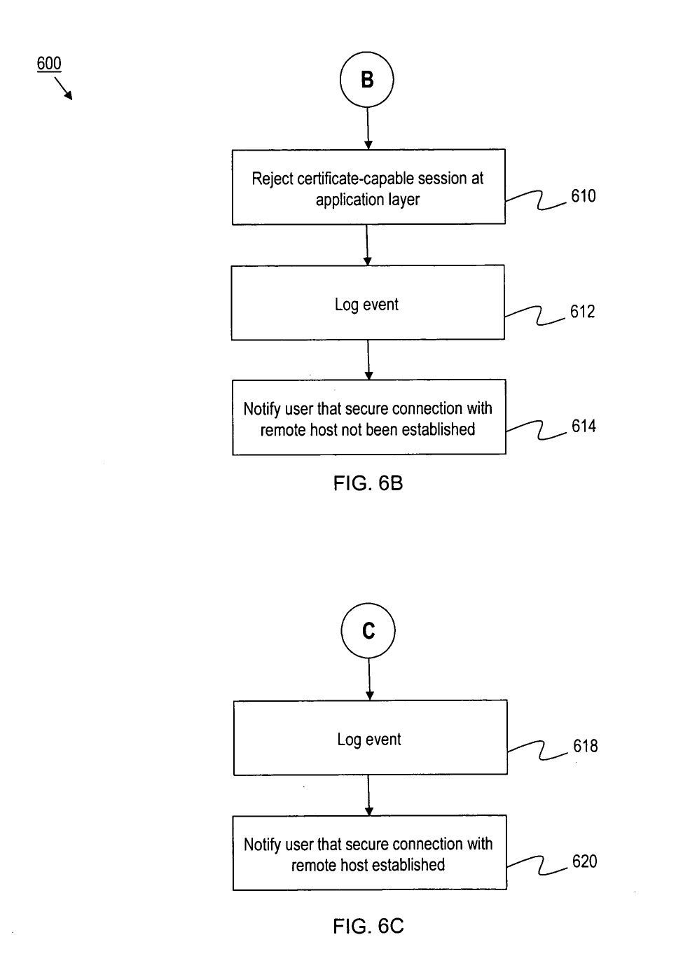

A method 600 of quickly and easily authenticating a remote host (e.g., the server 204) in a certificate-capable session, according to an exemplary embodiment, is shown in FIG. 6. The method 600 may be implemented by the device 502, as described above. In the method 600, it is determined whether or not a certificate-capable session has been initiated (step 602). If a request for a certificate-capable session with a remote host is detected (“Yes” in step 602), the digital certificate of the remote host is intercepted and analyzed (step 604). Optionally, the user may be notified of the certificate-capable session request (step 606).

It is then determined whether or not the certificate-capable session request should be granted (step 608). For example, the certificate-capable session request may be denied because information in the digital certificate of the remote host indicates that the digital certificate is invalid, the issuer of the digital certificate is absent from a maintained whitelist, the issuer of the digital certificate is present on a maintained blacklist, etc. If the remote host cannot be authenticated (“No” in step 608), the certificate-capable session request (for a secure connection to the remote host) should be denied (step 610). The rejection of the certificate-capable session request is recorded in a log (step 612). The user is notified that a secure connection with the remote host has not been established (step 614).

If the remote hose is authenticated as a trusted entity (“Yes” in step 608) and no grounds for denying the certificate-capable session request exists, the certificate-capable session request is granted and a secure connection is established with the remote host (step 616). The granting of the certificate-capable session request is recorded in a log (step 618). The user is notified that a secure connection with the remote host has been established (step 620).

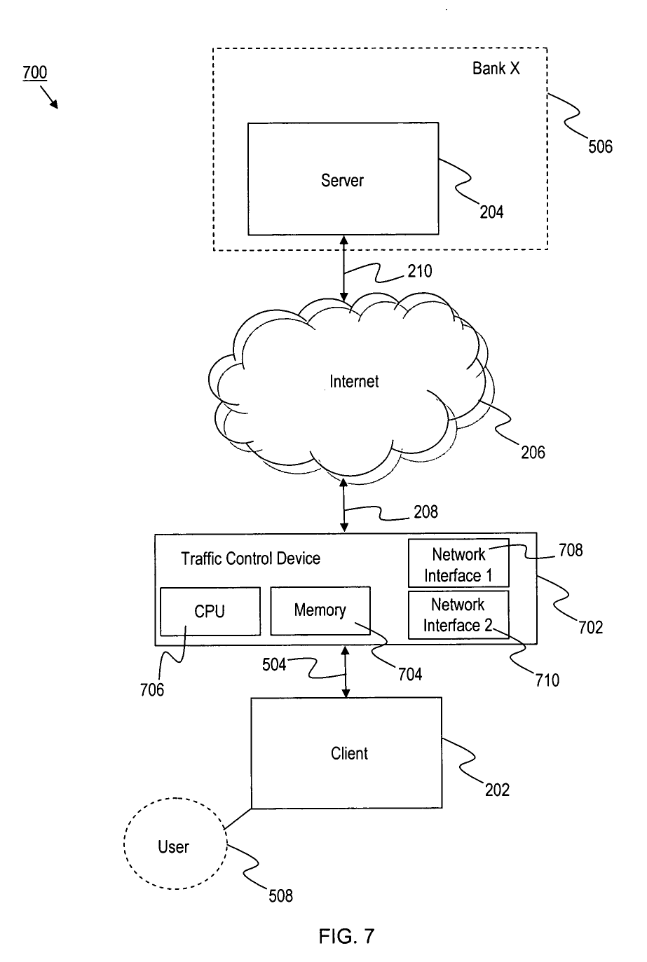

A system 700 for performing traffic control by analyzing properties of a digital certificate in a certificate-capable session, according to an exemplary embodiment, is shown in FIG. 7. In the system 700, a device 702(e.g., an SSL firewall) is provided for selectively blocking or passing computer network traffic based on properties of a certificate-capable session. The device 702 extends conventional network firewalls, which analyze network properties such as TCP/IP addresses, ports and other low-level network information, by expanding the properties that are analyzed to include high-level digital certificate properties such as the issuer, the subject, the signer, the expiration status, etc.

In one exemplary embodiment, the device 702 is a stand-alone network appliance that monitors a network connection 208. The appliance, in whole or in part, may be implemented as hardware, software or a combination of hardware and software. For example, the device 702 may include memory 704 (e.g., random access memory (RAM) for temporary storage and/or flash memory for persistent storage), a central processing unit (CPU) 708 and one or more network interface units 710, 712, which are operable to monitor network traffic, analyze network traffic and perform traffic control based on the monitored network traffic.

In FIG. 7, the device 702 is located in-line in a wired network 504 (e.g., an Ethernet network). The device 702, however, does not need to be located in-line and will function on any appropriate wired or wireless network. Furthermore, the device 702 could be embedded in a NIC, provided as a freestanding network device or integrated into existing network devices/appliances such as routers, firewalls, etc. In FIG. 7, the device 702 is shown as physically separate from the client 202. The device 702, however, does not need to be physically separate from the client 202. For example, the device 702 may be physically and/or logically integrated into the client 202 and/or the infrastructure of the network 504.

The device 702 observes network traffic flowing between a network (e.g., the Internet 206) and the client 202 by monitoring the network connection 208. The device 702 may monitor network traffic flowing in either or both directions (i.e., upstream, downstream or both). If a certificate-capable session (e.g., an SSL session) is detected by the device 702, the device 702 analyzes the digital certificate 100 associated with the client 202 and/or the server 204 to determine whether or not the network traffic is authorized. The device 702 may participate in this decision process directly or indirectly. The participation in the decision process by the device 702 may be at the network layer or the application layer. For example, network layer TCP resets and/or conventional network firewall filtering may be employed once an undesirable connection is detected. Application layer techniques, such as interaction with the SSL handshake sequence, may also be employed. Furthermore, additional data may be provided to the user 508 by modifying an existing session (e.g., an HTTP session) or by creating a new session. For example, the device 702 may alert the user 508 to sites that are suspected of being malicious but are unconfirmed. Moreover, more clever redirections are contemplated such as transparent redirection of sessions for monitoring and filtering (e.g., e-mail spam, virus, content filtering, etc. via transparent redirection of Internet Message Access Protocol (IMAP), Post Office Protocol (POP) and Simple Mail Transfer Protocol (SMTP) sessions; web content filtering through redirection of HTTP sessions; etc.). In a general redirection scheme, traffic traveling to or from the client 202 and/or the server 204 passes through the device 702, which redirects the traffic (e.g., to a filter) for processing before allowing the traffic to pass through.

By analyzing the information in the digital certificate 100, the device 702 selects an appropriate operation based on a predefined security policy. The predefined security policy may include rules based on the existence of the digital certificate 100, the validity of the digital certificate 100, the issuer of the digital certificate 100, the signer of the digital certificate 100, or any other property, field or data item contained in the digital certificate 100. Additionally, the authorization decision may be based on a comparison of the data in the digital certificate 100 and the actual host/session data. Furthermore, the authorization decision may be based on the revocation status of the digital certificate 100 as determined, for example, via remote lookup and/or a local list. Further still, the authorization decision may be based on the presence of the digital certificate 100 on a whitelist, a blacklist or any other configurable “approved list.” Additionally, the authorization decision may take into account local user policies and preferences and/or third party policies and preferences.

Based on the information in the digital certificate 100 and according to the predefined security policy, the device 702 performs an appropriate operation with respect to the network traffic flow. In particular, the device 702 may permit the traffic to flow unaltered, deny the flow of the traffic, modify the traffic, alert the user 508, log an event or provide real time feedback and additional data on the event to the user 508. The user 508 may be alerted, for example, audibly and/or visually. The events to be logged may include, for example, each instance when a certificate-capable session is initiated, denied, attempted, completed, has failed, etc. Furthermore, the logs may also include any of the data collected by the device 702. Preferably, but not necessarily, the transaction logs are stored electronically. For example, the transaction logs may be stored locally on the device 702 or on the client 202 (e.g., for the user 508 to review) or at a remote location (e.g., for third party analysis). Software on the client 202 is used to provide the real time feedback to the user 508. The software may be a Web page, a modification to a Web page flowing through the device 702, an application installed on the client 202, etc.

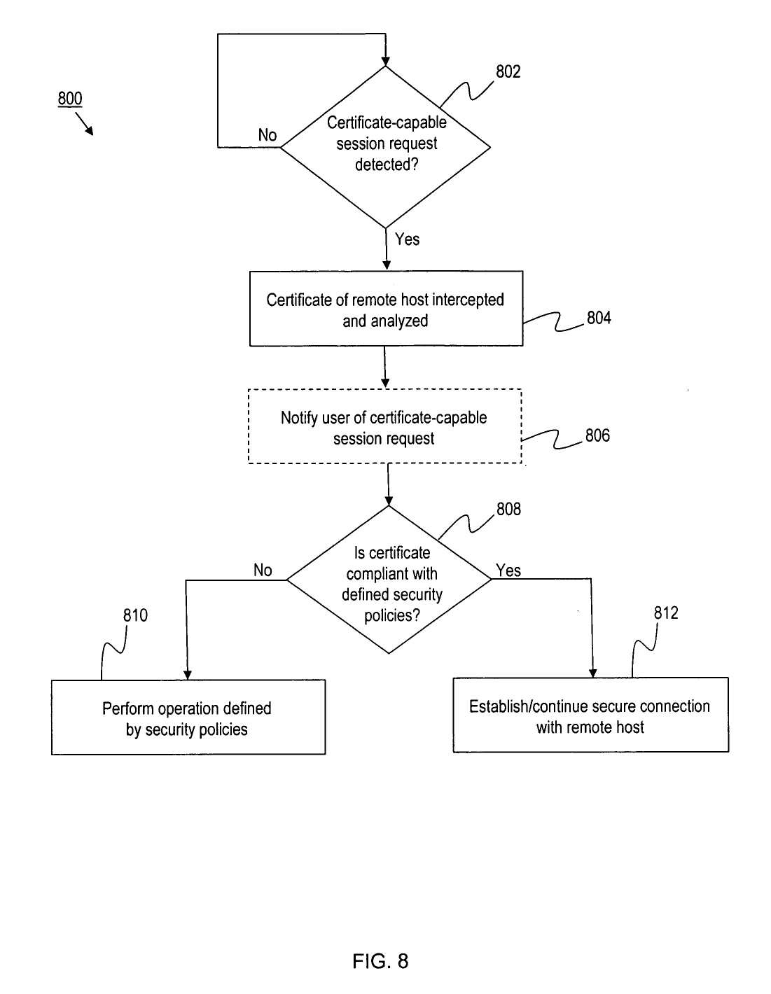

A method 800 of performing traffic control by analyzing properties of a digital certificate in a certificate-capable session, according to an exemplary embodiment, is shown in FIG. 8. The method 800 may be implemented by the device 702, as described above. In the method 800, it is determined whether or not a certificate-capable session has been initiated (step 802). If a request for a certificate-capable session with a remote host is detected (“Yes” in step 802), the digital certificate of the remote host is intercepted and analyzed (step 804). Optionally, the user may be notified of the certificate-capable session request (step 806).

It is then determined whether or not the digital certificate (and its related certificate-capable session request) is compliant with predefined security policies. The predefined security policies may be implemented, for example, as a series of rules, criteria, etc. If the digital certificate fails to comply with the predefined security policies (“No” in step 808), an appropriate action is performed with respect to the network traffic flow, such as permitting the traffic to flow unaltered, denying the flow of the traffic, modifying the traffic, alerting the user, logging an event or providing real time feedback and additional data to the user (step 810). If the digital certificate complies with the predefined security policies (“Yes” in step 808), a secure connection is established with the remote host or an existing secure connection continues normally (step 812).

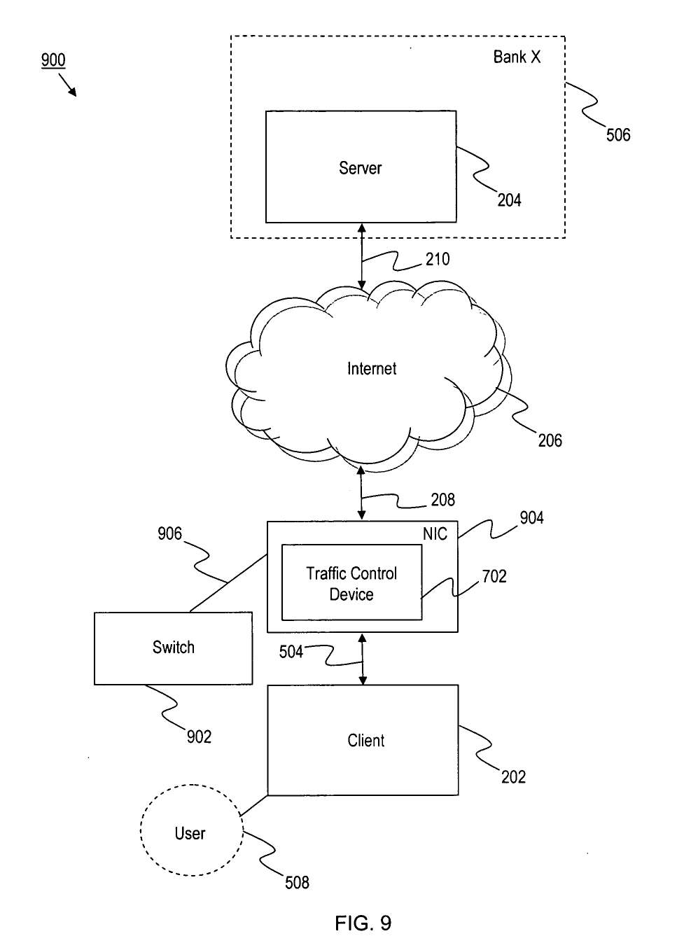

According to yet another exemplary embodiment, a system 900 for performing traffic control by analyzing properties of a digital certificate in a certificate-capable session is shown in FIG. 9. In the system 900, a device 702 is provided for selectively blocking or passing computer network traffic based on properties of a certificate-capable session and a switch 902 is provided for controlling the operation of the device 702. The operation of device 702 was described above with reference to FIG. 7.

In one exemplary embodiment, the device 702 is embedded in NIC 904 of the client 202 in the Ethernet network 504. The device 702, however, does not need to be embedded into the NIC 904 and will function on any appropriate wired or wireless network. In FIG. 9, the device 702 is shown as physically separate from the client 202. The device 702, however, does not need to be physically separate from the client 202. For example, the device 702 may be physically and/or logically integrated into the client 202 and/or the infrastructure of the network 504.

In FIG. 9, the switch 902 is shown as a physical switch connected to the NIC 904 containing the device 702 via a short cable 906. The switch 902, however, does not need to be a physical device and could be implemented as software or a logical switch. Preferably, but not necessarily, the switch 902 is only implemented as software or a logical switch if contemplated advances in trusted hardware and software technologies, such as those from the Trusted Computing Group (TCG), are provided. Furthermore, the switch 902 does not need to be connected to the NIC 904/device 702 via the short cable 906. Instead, the switch 902 can be connected to the NIC 904/device 702 wirelessly, for example, via Bluetooth, 802.11, etc.

The switch 902 has multiple positions for controlling the operation of the device 702. For example, the switch 902 may have a first position and a second position corresponding to a “secure only” and an “allow all” setting, respectively. A switch 902 with more positions could be used to allow fine-tuning the of the traffic control performed by the device 702, such as allowing access only to certain Web sites based on SSL certificate properties, local security policies, provider-based security policies and/or personal preferences. As another example, the switch 902 may have a first position, a second position and a third position corresponding to a “secure only,” a “prudent” and an “allow all” setting, respectively. The “prudent” setting would permit traffic based on a security policy that, for example, disallowed expired or invalid digital certificates. Another version of the switch 902 with a first position and a second position corresponding to an “audible alert” and a “silent alert” setting, respectively, is also possible. As one example, if the switch 902 is in the first position, corresponding to the “secure only” setting, the device 702 blocks all network traffic except SSL traffic conforming to a predefined security policy. If the switch 902 is in the second position, corresponding to the “allow all” setting, the device 702 is effectively disabled and all network traffic is allowed to flow unobstructed through the NIC 904 and the device 702.

An example of using the switch 902 to control the device 702 will now be described with reference to FIG. 9. The NIC 904 (e.g., the device 702) is loaded with the digital certificate 100 of Bank X 506, which is called a “registration.” Preferably, but not necessarily, the device 702 will periodically retrieve all current registrations from a central repository maintained by a third party (e.g., a device provider or other designee). Optionally, the device 702 may automatically retrieve the registrations without requiring user input.

Thereafter, the user 508 is randomly surfing the Internet 206. The switch 902 is in the “allow all” position providing the user 508 unrestricted access to the Internet 206. The user then desires to use an on-line banking system offered by Bank X 506. Accordingly, the user 508 moves the switch 902 to the “secure only” position. The device 702 now only permits the flow of secure (e.g., SSL encrypted) traffic with hosts for which the device 702 has digital certificates 100. All other traffic is denied. The user 508 can interact freely in the on-line environment offered by Bank X 506 knowing that the device 702 will not permit data to be transmitted to nor received from any non-secure site.

While the switch 902 is in the “secure only” position, the user 508 can interact freely with any on-line system or Web site that has successfully completed the registration process for the device 702. The device 702, controlled by the switch 902, can be used to permit only encrypted traffic to flow between the client computer 202 of the user 508 and known, trusted remote hosts validated by their digital certificates 100. When the user 508 is done transacting business on-line, the user 508 can move the switch 902 back to the “allow all” position for unrestricted browsing of the Internet 206.

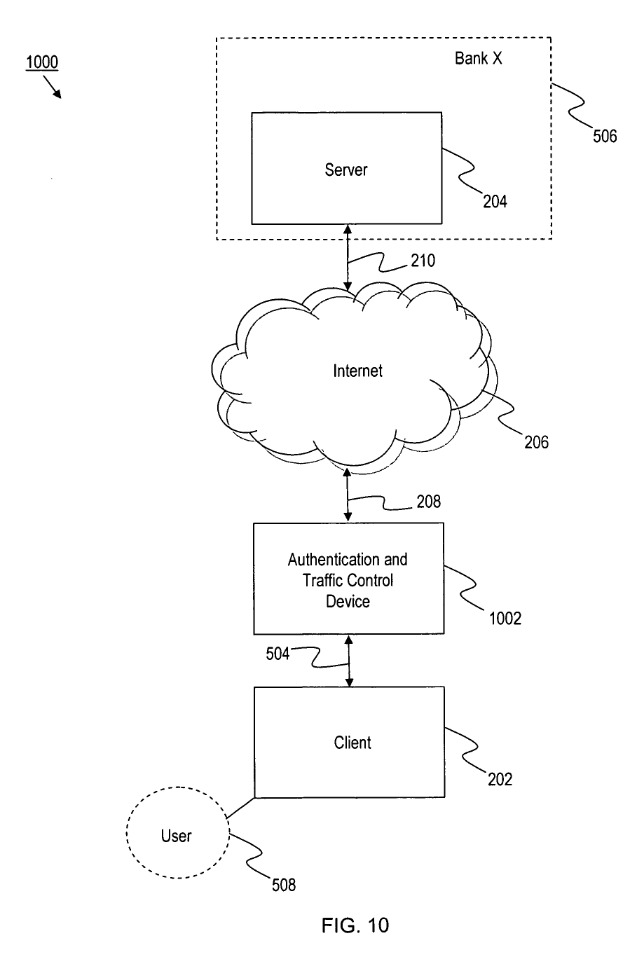

A system 1000 for authenticating a remote server 204 and performing traffic control in a certificate-capable session, according to an exemplary embodiment, is shown in FIG. 10. In the system 1000, a device 1002 is provided for both authenticating the remote server 204 (e.g., a web server of Bank X 506) independent of a local client 202 (e.g., a web browser of the user 508) and selectively blocking and passing network traffic, based on analysis of the digital certificate 100 of the server 204. The device 1002 implements the functions of the devices 502 and 702 described above with reference to FIGS. 5 and 7, respectively. In one exemplary embodiment, the device 1002 is embedded in a NIC 904 of the client 202.

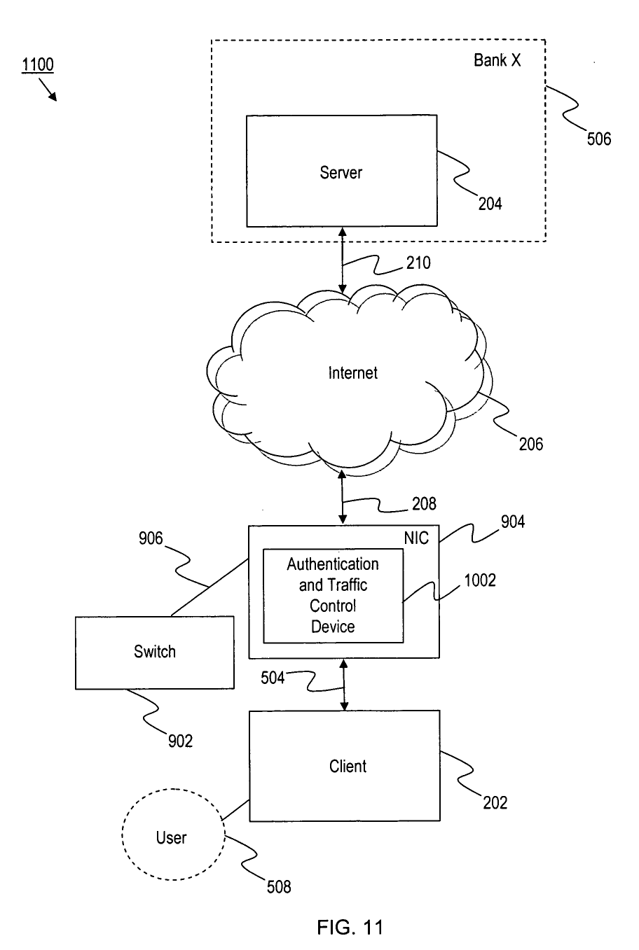

A system 1100 for authenticating a remote server 204 and performing traffic control in a certificate-capable session, according to an exemplary embodiment, is shown in FIG. 11. The system 1100 includes the device 1002, which is described above with reference to FIG. 10. The system 1100 also includes the switch 902, which is described above with reference to FIG. 9. The switch 902 is used to control operation of the device 1002, for example, when performing traffic control in a certificate-capable session.

The above description of specific embodiments has been given by way of example. From the disclosure given, those skilled in the art will not only understand Applicants' general inventive concept and its attendant advantages, but will also find apparent various changes and modifications to the structures and methods disclosed. For example, it will be appreciated that while various embodiments have been described with reference to an SSL certificate-capable environment, the general inventive concept encompasses other authentication and/or encryption technologies and techniques. It is sought, therefore, to cover all such changes and modifications as fall within the spirit and scope of the general inventive concept, as defined by the appended claims, and equivalents thereof.

I claim:

1. An apparatus for authenticating a remote host, said apparatus comprising:
monitor means for monitoring a network connection between a client and said remote host;
detection means for detecting initiation of a certificate-capable session between said client and said remote host;
analysis means for analyzing information in a digital certificate of said remote host provided in response to said initiation of said certificate-capable session; and
authentication means for authenticating an identity of said remote host based on said information in said digital certificate of said remote host.

2. The apparatus of claim 1, further comprising identification means for associating a unique identifier with said apparatus, said unique identifier operable to be cryptographically authenticated.

3. The apparatus of claim 1, wherein said apparatus is external to and in communication with said client.

4. The apparatus of claim 1, further comprising notification means for notifying a user of said client of said initiation of said certificate-capable session.

5. The apparatus of claim 1, wherein said authentication means authenticates said identity of said remote host at an application layer.

6. The apparatus of claim 1, wherein said authentication means determines if said digital certificate is valid.

7. The apparatus of claim 1, wherein said authentication means determines if said digital certificate is listed in one of a whitelist and a blacklist.

8. The apparatus of claim 1, further comprising session means for performing one of accepting and rejecting said certificate-capable session based on said information in said digital certificate.

9. The apparatus of claim 1, further comprising log means for logging a status of at least one of said digital certificate and said certificate-capable session.

10. The apparatus of claim 1, wherein said apparatus uses software installed on said client to provide real-time feedback to a user of said client.

11. The apparatus of claim 1, wherein said apparatus is embedded in a network interface card which is configured for installation in said client.

12. The apparatus of claim 1, wherein said apparatus is embedded in a network device.

13. An apparatus for controlling a traffic flow across a network connection between a client and a remote host, said apparatus comprising:
monitor means for monitoring said network connection;
detection means for detecting initiation of a certificate-capable session between said client and said remote host; and
filter means for using a digital certificate of said remote host provided in response to said initiation of said certificate-capable session to determine an operation to be performed on data in said traffic flow.

14. The apparatus of claim 13, further comprising redirection means for redirecting said data in said traffic flow.

15. The apparatus of claim 13, wherein said apparatus is external to and in communication with said client.

16. The apparatus of claim 13, wherein said filter means analyzes information in said digital certificate.

17. The apparatus of claim 16, wherein said information in said digital certificate includes at least one of validity information, an issuer, a signer, and a subject.

18. The apparatus of claim 13, wherein said filter means determines said operation to be performed on said data in said traffic flow based on a revocation status of said digital certificate.

19. The apparatus of claim 13, wherein said filter means determines said operation to be performed on said data in said traffic flow based on whether said digital certificate is listed in one of a whitelist and a blacklist.

20. The apparatus of claim 13, wherein said operation is one of allowing said traffic flow to pass without modification, allowing said traffic flow to pass with modification, allowing said traffic to pass after redirection of said traffic flow and blocking said traffic flow from passing.

21. The apparatus of claim 13, wherein said operation is one of allowing said certificate-capable session and blocking said certificate-capable session.

22. The apparatus of claim 13, wherein said operation is notifying a user of said client of a status of at least one of said digital certificate and said certificate-capable session.

23. The apparatus of claim 13, wherein said operation is logging a status of at least one of said digital certificate and said certificate-capable session.

24. The apparatus of claim 13, wherein said operation is using software installed on said client to provide real-time feedback to a user of said client.

25. The apparatus of claim 13, wherein said filter means uses at least one predefined rule to determine said operation to be performed on said data in said traffic flow.

26. The apparatus of claim 13, wherein said apparatus is embedded in a network interface card.

27. The apparatus of claim 13, wherein said apparatus is embedded in a network device.

28. The apparatus of claim 13, further comprising a switch, said switch operable to control said filter means.

29. The apparatus of claim 28, wherein said switch includes a plurality of settings, each setting corresponding to a different security policy.

30. The apparatus of claim 28, wherein said switch is a physical switch, and wherein said switch includes a plurality of positions, each position corresponding to a different security policy.

31. The apparatus of claim 28, wherein said switch is implemented in software.

32. The apparatus of claim 28, wherein said apparatus is embedded in a network interface card, and
wherein said switch is connected to said network interface card.

33. The apparatus of claim 32, wherein said switch is in wireless communication with said network interface card.
